(19) United States
(12) Patent Application Publication
(10) Pub. No.: US 2026/0125012 A1
(43) Pub. Date: May 7, 2026

(54) VEHICLE WINDOW CONTROL METHOD AND VEHICLE WINDOW CONTROL DEVICE

(71) Applicants: Hyundai Motor Company, Seoul (KR); Kia Corporation, Seoul (KR)

(72) Inventors: Jun ZHOU, Yantai (CN); Yicheng FAN, Yantai (CN); Sungbo YANG, Yantai (CN); Yao YAO, Yantai (CN)

(21) Appl. No.: 19/379,251

(22) Filed: Nov. 4, 2025

(30) Foreign Application Priority Data
Nov. 7, 2024 (CN) 202411580916.9

(51) Int. Cl. B60R 16/037; G06T 7/50; G06T 7/73; G06V 20/59; G06V 40/16; G10L 15/08; G10L 15/22

(52) U.S. Cl. CPC B60R 16/0373; G06T 7/50; G06T 7/73; G06V 20/59; G06V 40/166; G06V 40/171; G10L 15/08; G10L 15/22; G06T 2207/10048; G06T 2207/30201; G06T 2207/30268; G10L 2015/088

(57) ABSTRACT

The present disclosure relates to a multi-mode vehicle window control method and device. The method combines voice recognition and computer vision technologies, detects a user's voice wake-up word using a vehicle-mounted microphone, turns on the vehicle-mounted camera to detect the user's face and head, analyzes the user's gaze, face pose, and head posture to estimate the user's attention region, and aligns the attention region with a vehicle body coordinate system. Intelligent control of a vehicle window is realized according to specific coordinates of an attention area on the vehicle window. Even if the user's face or eyes are not detected, the vehicle window may be operated accurately by determining the user's intention through the face or head pose.

### CROSS-REFERENCE TO RELATED APPLICATION

This application claims the benefit of priority to Chinese Patent Application No. 202411580916.9 filed in the Chinese National Intellectual Property Administration on Nov. 7, 2024, the entire contents of which are incorporated herein by reference.

### TECHNICAL FIELD

The present disclosure relates to vehicle control technology, and more particularly, to a multi-mode vehicle window control method combining computer vision and voice recognition.

### BACKGROUND

The matters described in this Background section are only for enhancement of understanding of the background of the disclosure, and should not be taken as acknowledgment that they correspond to prior art already known to those skilled in the art.

A control of vehicle comfort, convenience, and intelligence may be a core element in design and manufacturing of vehicles. With the advancement of technology, vehicle window control systems may be also gradually evolving toward automation and intelligence. However, vehicle window control may primarily rely on manual operation, which realizes the lifting of the vehicle window through a physical button or switch. While this method is simple and intuitive, it has certain limitations in practical use.

First, manual control requires the driver or a passenger to directly operate a button, which may cause inconvenience to the driver or passenger in certain situations. For example, when the driver needs to focus on driving, operating the vehicle window button may distract attention, which may affect driving safety. In addition, in an emergency situation, a quick reaction to open or close the vehicle window may be limited.

Next, vehicle window control technologies may lack the ability to intelligently sense the in-cabin environment and the occupant's intention. The opening and closing status of the vehicle window often may not be dynamically adjusted according to changes in the vehicle's interior and exterior environment and the needs of the occupants. For example, when the in-cabin air quality is poor, the system may not automatically adjust the vehicle window to improve airflow, or when external noise is too loud, it may not automatically close the vehicle window to reduce noise interference.

To address the aforementioned issues, some technologies may introduce computer vision and artificial intelligence technologies to improve the intelligence level of vehicle window control. For example, through camera and image processing technology, the system may recognize an in-cabin occupant's facial expression, gaze direction, and even gesture movements. By combining voice recognition technology, the vehicle window control system may receive and interpret passengers'voice commands to realize more intuitive and convenient operation.

Such technologies may improve the degree of automation of vehicle window operation and reduce the need for manual operation, which improves the convenience of vehicle window control to a certain extent. However, vision control may rely heavily on the gaze direction of the human eye, and if the human eye is occluded, blurred, lost, or the face is lost, the estimation of the gaze direction is lost, which may lead to a lack of control information and greatly impact the user experience. Furthermore, due to the limited accuracy, stability, and convenience, it may be difficult to satisfy the needs of a convenient and fast intelligent cabin.

### SUMMARY

An example of the present disclosure provides a vehicle window control method that integrates vision and voice multi-modes that may accurately perform vehicle window control even if there are no eyes or no face.

According to the present disclosure, a method performed by an apparatus of a vehicle may comprise detecting, via a microphone of the vehicle, a spoken preset wake-up word associated with a user of the vehicle, turning on a sensor of the vehicle based on the detecting of the spoken preset wake-up word, obtaining, via the sensor, image data associated with a face and a head of the user, and determining, based on the image data, a face state of the user.

The method may further comprise performing at least one of the following: when the face state indicates that eyes on the face are visible, estimating a gaze of the user and setting, as a first attention region, a projection region of the vehicle toward which the gaze is directed; when the face state indicates that eyes on the face are invisible and the face is visible, estimating a face pose of the user and setting, as a second attention region, a projection region of the vehicle toward which the face pose is directed; or when the face state indicates that the face is invisible, estimating a head pose of the user and setting, as a third attention region, a projection region of the vehicle toward which the head pose is directed. The method may further comprise aligning one attention region of the first attention region, the second attention region, or the third attention region with a body coordinate system of the vehicle to determine coordinates of attention of the user on a window of the vehicle, and based on the spoken preset wake-up word and the coordinates of the attention on the window, performing opening or closing control of the window.

According to the present disclosure, an apparatus of a vehicle may comprise a microphone configured to detect a spoken preset wake-up word of a user, a sensor configured to obtain image data associated with a face and a head of the user, and a processor circuit. The processor circuit may be configured to turn on the sensor based on the spoken preset wake-up word, determine, based on the image data, a face state of the user, and based on the face state of the user indicating that eyes on the face are visible, estimate a gaze of the user and set, as a first attention region, a projection region of the vehicle toward which the gaze is directed.

The processor circuit may also be configured to, based on the face state of the user indicating that eyes on the face are invisible and the face is visible, estimate a face pose of the user and set, as a second attention region, a projection region of the vehicle toward which the face pose is directed.

The processor circuit may further be configured to, based on the face state of the user indicating that the face is invisible, estimate a head pose of the user and set, as a third attention region, a projection region of the vehicle toward which the head pose is directed.

The processor circuit may be further configured to align one attention region of the first attention region, the second attention region, or the third attention region, with a body coordinate system of the vehicle to determine coordinates of attention of the user on a window of the vehicle, and based on the spoken preset wake-up word and the coordinates of the attention on the window, perform opening or closing control of the window.

The processor circuit may be configured to perform point detection on the face to obtain coordinate information of facial feature points and estimate glabella depth using the coordinate information of the facial feature points to determine depth information associated with the face in a three-dimensional space.

The processor circuit may be configured to perform the opening or closing control of the window based on the attention remaining longer than a predetermined duration threshold. The processor circuit may be configured to perform the opening or closing control of the window based on a determination that the attention remains on a preset position in the vehicle longer than a predetermined duration threshold.

The processor circuit may be configured to perform dynamic calibration on the sensor to obtain external parameter information of the sensor with respect to the body coordinate system, wherein the external parameter information is used to align the image data with the body coordinate system when the sensor is at different positions.

The processor circuit may be configured to obtain external parameter information of the sensor with respect to the body coordinate system, wherein the external parameter information is configured to be used to align the image data with the body coordinate system.

According to the present disclosure, a vehicle may comprise at least one sensor configured to obtain interior data of the vehicle, wherein the interior data may comprise at least one of voice data of an occupant and image data of the occupant captured within a cabin of the vehicle, and a processor circuit.

The processor circuit may be configured to detect, from the voice data, a voice command associated with a window of the vehicle, process, from the image data, at least one of a gaze vector, a face pose, or a head pose of the occupant to estimate an attention region of the occupant, determine, based on the estimated attention region, a position of the window, output, based on the detected voice command and the position of the window, a signal indicating to operate the window, and control, based on the signal, operation of the window. The processor circuit may be configured to detect a user-defined wake-up word as part of the voice command associated with the window.

The processor circuit may be configured to prioritize execution of the operation of the window based on a voice command of a driver of the vehicle over a voice command of a passenger of the vehicle. The processor circuit may be configured to, when eyes of the occupant are invisible, estimate the attention region based on the face pose. The processor circuit may be configured to, when both eyes and face of the occupant are invisible, estimate the attention region based on the head pose.

The processor circuit may be configured to generate the signal based on the attention region remaining on the window for at least a predetermined time period. The processor circuit may be configured to, based on determining lighting conditions inside the cabin as insufficient, obtain an infrared image of the occupant and perform face depth estimation using the infrared image. The processor circuit may be configured to, based on determining at least one of a vehicle speed, an outside temperature, or a stored user preference, control a degree of opening of the window.

In addition, the effects that may be obtained or expected from the examples of the present disclosure will be directly or implicitly disclosed in the detailed description of the present disclosure. That is, various effects expected from the examples of the present disclosure will be described in the following detailed description.

### BRIEF DESCRIPTION OF THE DRAWINGS

FIG. 1 shows an exemplary overall system structure of an example of the present disclosure.

FIG. 2 shows a flowchart of an example of the present disclosure.

FIG. 3 shows an example of an eye-gaze vector estimation flow according to an example of the present disclosure.

FIG. 4 shows an example of a face depth estimation flow according to an example of the present disclosure.

FIG. 5 shows an example of a camera dynamic calibration flow according to an example of the present disclosure.

FIG. 6 shows an example of a head pose estimation flow with a face according to an example of the present disclosure.

FIG. 7 shows an example of a head pose estimation flow without a face according to an example of the present disclosure.

FIG. 8 shows an example of an estimation result of an attention direction vector according to an example of the present disclosure.

FIG. 9 shows an example of an effect of an attention area according to an example of the present disclosure.

FIG. 10 shows an example of an effect of an attention area according to an example of the present disclosure.

FIG. 11 shows an example of an effect of an attention area according to an example of the present disclosure.

FIG. 12 shows an example computing system.

### DETAILED DESCRIPTION

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated or adjusted based on the feature of multi-mode driver attention tracking for intelligent vehicle control (e.g., combining gaze estimation, face pose, and head pose to assess driver attentiveness). Such activation may be based on configured autonomous driving control setting(s) (e.g., based on at least one of: an autonomous driving classification, a selection of an autonomous driving level for a vehicle, etc.). Using the multi-mode tracking feature, the system may automatically switch or modulate autonomous driving functions depending on whether the driver is attentive, distracted, or unresponsive (e.g., escalating from a hands-on assist mode to a higher autonomy mode or triggering a safe stop, etc.).

Based on the multi-mode tracking feature described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.) that are adaptively tuned based on the detected driver attention state.

One or more auxiliary devices (e.g., engine brake, exhaust brake, hydraulic retarder, electric retarder, regenerative brake, etc.) may also be controlled, for example, based on the feature of multi-mode driver attention tracking for intelligent vehicle control (e.g., combining gaze estimation, face pose, and head pose to assess driver attentiveness). For example, when the system detects reduced driver attentiveness or delayed reaction through the multi-mode tracking feature, it may automatically engage or increase auxiliary braking to slow the vehicle more safely (e.g., applying engine braking sooner on steep downhill segments, activating regenerative braking more aggressively in heavy traffic, or activating an electric retarder during a distraction event, etc.). Conversely, when the driver's attentiveness is confirmed as high, the system may allow more gradual or driver-preferred auxiliary braking behavior. By dynamically linking auxiliary device control to the detected driver attentiveness, the system enhances vehicle safety, stability, and energy efficiency while reducing the likelihood of incidents during inattentive driving periods.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on the feature of multi-mode driver attention tracking for intelligent vehicle control (e.g., combining gaze estimation, face pose, and head pose to assess driver attentiveness). For example, when the multi-mode tracking feature detects that the driver's attention is reduced or diverted, the communication device may automatically adjust or restrict certain functions to minimize distraction (e.g., delaying non-critical notifications, muting incoming calls, or suppressing pop-up alerts on the infotainment display, etc.). Conversely, when the driver's attention level is high, the system may permit or prioritize communications (e.g., enabling vehicle-to-everything (V2X) safety messages, initiating an emergency call, or allowing hands-free voice interactions, etc.). By dynamically linking communication device behavior to the detected driver attentiveness, the system improves safety and user experience while maintaining necessary connectivity.

Minimum risk maneuver (MRM) operation(s) may also be controlled, for example, based on the feature of multi-mode driver attention tracking for intelligent vehicle control (e.g., combining gaze estimation, face pose, and head pose to detect driver inattentiveness or incapacity). A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. Using the multi-mode tracking feature, the system may automatically trigger or modify the MRM when it detects that the driver's attention has lapsed beyond a threshold (e.g., prolonged eye closure, head turned away, or loss of gaze direction, etc.).

A minimal risk maneuver may be an operation that may be activated during autonomous driving of the vehicle when a driver is unable to respond to a request to intervene. For example, upon detecting insufficient driver attention by the multi-mode tracking feature, the vehicle may execute a safe stop on the shoulder, reduce speed, or activate hazard lights while maintaining a safe lateral distance from other vehicles. During the minimal risk maneuver, one or more processors of the vehicle may control a driving operation of the vehicle for a set period of time while continuously monitoring the driver's state to determine when control can be safely returned.

Biased driving operation(s) may also be controlled, for example, based on the feature of multi-mode driver attention tracking for intelligent vehicle control (e.g., combining gaze estimation, face pose, and head pose to assess the driver's lateral awareness). A driving control apparatus may perform a biased driving control by dynamically adjusting lateral positioning in response to the driver's detected attention state. To perform biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane when the driver's gaze indicates a higher focus on one side (e.g., an adjacent vehicle, roadside hazard, or merging traffic, etc.). The driving control apparatus may identify or determine a biased target lateral distance for biased driving control using attention data from the multi-mode tracking feature. For example, a biased target lateral distance may comprise an intentionally adjusted lateral distance that a vehicle may aim to maintain from a reference point, such as the center of a lane or another vehicle, during maneuvers such as lane changes. This adjustment may be made adaptively based on the driver's attention, increasing the gap to adjacent vehicles if the system detects distraction, or reducing bias when the driver is highly attentive. This adjustment may be made to improve the vehicle's stability, safety, and/or performance under varying driving conditions. For example, during a lane change, the driving control system may bias the lateral distance to keep a safer gap from adjacent vehicles, considering factors such as the vehicle's speed, road conditions, and/or the presence of obstacles together with the detected driver attentiveness.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled or dynamically adjusted, for example, based on the feature of multi-mode driver attention tracking for intelligent vehicle control (e.g., combining gaze estimation, face pose, and head pose to assess driver attentiveness). Through this feature, the system may automatically select or weight sensor inputs differently depending on the driver's detected attention state (e.g., increasing camera or LIDAR sampling frequency when the driver is distracted, switching to redundant sensors when a primary sensor is obstructed, or enabling additional seatbelt/airbag readiness checks when attention drops, etc.). An operation control for autonomous driving of the vehicle may therefore include various driving controls by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.) that are triggered or modified based on sensor data processed together with the multi-mode driver attention tracking feature.

An autonomous driving level and/or autonomous driving activation/deactivation may also be controlled, for example, based on the feature of multi-mode driver attention tracking for intelligent vehicle control (e.g., combining gaze estimation, face pose, and head pose to assess driver attentiveness). A driving control apparatus may perform an autonomous driving level control (e.g., a change of an autonomous driving level, a change of a required user attentiveness, etc.) or cause deactivation of an autonomous driving operation based on the driver's attention state detected through the multi-mode tracking feature. For example, by changing the required user attentiveness determined from gaze, face pose, and head pose analysis, the driver may be required to place his/her hands on the steering wheel more often (e.g., at least once in a threshold time period, such as five seconds, 30 seconds, 1 minute, etc.). By changing the required user attentiveness derived from the multi-mode tracking feature, the driver may also be required to look ahead more often (e.g., at least once in a threshold time period, such as five seconds, 30 seconds, 1 minute, etc.). By changing the autonomous driving level based on the multi-mode driver attention tracking feature, one or more video contents may not be displayed on a display of the vehicle to prevent distraction during critical driving states.

According to the present disclosure, a vehicle window control method and apparatus are provided that enable intuitive and safe operation of vehicle windows through a multi-mode human-machine interface. The method combines voice recognition and computer vision technologies such that, upon detecting a wake-up word from a vehicle-mounted microphone, a cabin camera is activated to capture a user's face, eyes, and head posture. The captured data are processed to estimate a gaze vector, face pose, or head pose, and the resulting attention region is aligned with a vehicle body coordinate system to identify a specific window. Even if the user's face or eyes are partially or completely obscured, the system determines intent based on available facial or head information and generates corresponding control signals to open, close, or adjust the selected window, thereby achieving accurate, hands-free, and context-adaptive vehicle window operation.

Hereinafter, a vehicle window control method and a vehicle window control device according to an example of the present disclosure will be described.

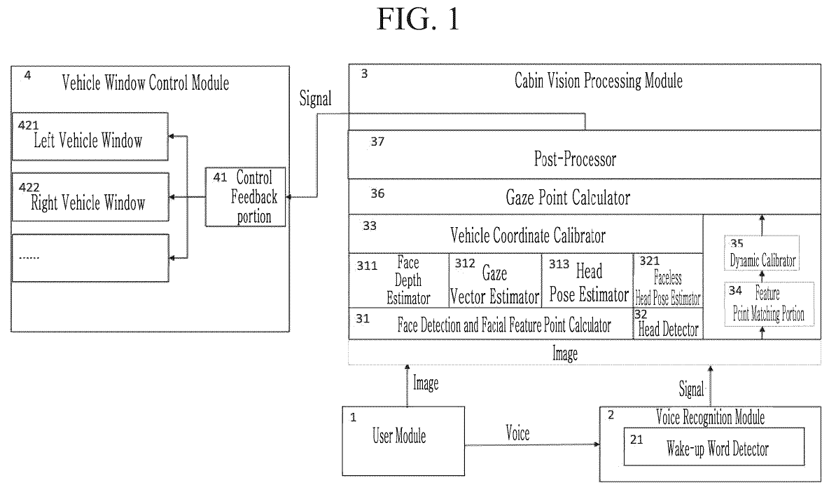

FIG. 1 shows an exemplary overall system structure of an example of the present disclosure. As shown in FIG. 1, a vehicle window control device according to an example of the present disclosure may include a user module 1, a voice recognition module 2, a cabin vision processing module 3, and a vehicle window control module 4.

The user module 1 is a starting point for interaction of the overall system, represents a final user of the system, and is a device for receiving input from a driver or passenger of a vehicle (e.g., a passenger car, a bus, or an autonomous shuttle, etc.). A user mainly interacts with the system through voice input and image input.

The voice input is processed using the voice recognition module 2, which will be described later. The user may activate and control the system by speaking a predefined voice command. This interaction method is very intuitive and allows users to control the vehicle windows without having to distract their gaze or use their hands. Voice commands may include, but are not limited to, specific commands such as “open the vehicle window,” “close the vehicle window,” and “open the left vehicle window (e.g., rear-left or front-left).”

The system may be designed to support various languages and dialects to accommodate the needs of different regions and user groups (e.g., English, Spanish, Mandarin, or Arabic, etc.).

The image input is processed using the cabin vision processing module 3, which will be described later. Vision information such as a user's facial expression, eye movement, and head pose (e.g., nodding, turning, or leaning, etc.) can be continuously captured by a cabin camera of the system. This vision information is an important basis for the system to recognize intent and determine whether to operate. For example, if a user continues to look at a specific vehicle window for a certain period of time (e.g., more than two seconds, three seconds, or a preset duration, etc.), the system may interpret this as an intent to operate the vehicle window.

The design philosophy of the user module emphasizes the naturalness and convenience of human-machine interaction. By combining two input methods-voice and image-the system may more accurately understand the user's intent, reduce the possibility of malfunction, and at the same time, improve driving safety. In addition, this design also considers the usage requirements in special situations, for example, when the light is insufficient or the surrounding noise is loud, or the user wears sunglasses, etc., the system may still operate normally through another input method.

The voice recognition module 2 is an auditory sensing portion of the system and is responsible for capturing and analyzing a user's voice command. The voice recognition module 2 includes a wake-up word detector 21, and the wake-up word detector 21 continuously monitors surrounding audio and specifically recognizes a predetermined wake-up word.

Since continuous operation is required, the wake-up word detector 21 generally uses a low-power consumption design to minimize an effect on a vehicle battery. In addition, it has a high-precision recognition ability, may accurately recognize the wake-up word in various surrounding noises (e.g., engine noise, road noise, or music playback, etc.), and at the same time, minimizes a possibility of false activation. The wake-up word detector 21 allows the user to self-define the wake-up word, thereby improving a user experience and a degree of personalization of the system. In addition, it may recognize wake-up words in various languages to adapt to the needs of international markets. Once the wake-up word is detected, the wake-up word detector 21 may quickly activate other portions of the system, thereby ensuring a smooth user experience. After recognizing the wake-up word, the wake-up word detector 21 may further analyze a user's specific voice command such as “open the front left vehicle window” or “close all vehicle windows,” (e.g., simultaneously or in sequence) and analyze more complex voice commands to understand a user's true intent, and is not limited to a predetermined command format. In addition, the wake-up word detector 21 may filter background noise, thereby improving an accuracy of voice recognition, especially in a driving vehicle environment. The wake-up word detector 21 may also have an ability to distinguish different speakers (e.g., a driver versus a passenger) to facilitate performing an operation according to a command of a driver or a specific passenger (e.g., prioritize a command of the driver over a command of a passenger, etc.).

The cabin vision processing module 3 is a vision processing center of the entire system and is responsible for capturing and analyzing user's vision information. The cabin vision processing module 3 includes a plurality of complex algorithms and processing units, and includes a face detection and facial feature point calculator 31, a head detector 32, a vehicle coordinate calibrator 33, a feature point matching portion 34, a dynamic calibrator 35, a gaze point calculator 36, and a post-processor 37, and each constituent element focuses on a specific vision analysis task.

The face detection and facial feature point calculator 31 detects the position of a face in an image in real-time, and for example, it positions and tracks facial point feature points, such as the corners of the eyes, the tip of the nose, and the corners of the mouth, or eyebrow edges, etc., to provide basic data for subsequent depth estimation, gaze tracking, and head pose estimation. The face detection and facial feature point calculator 31 may use deep learning algorithms, such as a convolutional neural network (CNN), to improve detection accuracy and speed.

The face detection and facial feature point calculator 31 includes a face depth estimator 311, a gaze vector estimator 312, and a head pose estimator 313. The face depth estimator 311 estimates the distance from a user's face to a camera. It may use monocular depth estimation technology or combine data from other sensors (e.g., an infrared sensor, a structured light sensor, or a stereo camera, etc.) to provide important spatial information for the accurate calculation of a gaze direction and a fixation point. The gaze vector estimator 312 calculates a user's gaze vector based on the eye position and pupil direction. The gaze vector estimator 312 may consider the influence of head pose on the gaze direction and may use an eye-tracking algorithm, such as the pupil-centered corneal reflection method (PCCR). The head pose estimator 313 estimates a three-dimensional pose of a user's head, which includes pitch, yaw, and roll angles, calculates it by combining it with facial feature point information and a 3D head model, and provides important supplementary information for estimating the gaze vector.

The head detector 32 is activated when a complete face cannot be detected (for example, in a side view or a backlight situation, or when the user wears a mask, etc.). The head detector 32 recognizes and tracks the contour and position of the head to provide necessary information for pose estimation when a face is not present. By using a shape model or machine learning methods, the head detector 32 may be used for various head shapes and hairstyles (e.g., short hair, long hair, or hats, etc.).

The head detector 32 includes a faceless head pose estimator 321. The faceless head pose estimator 321 is activated when complete facial features cannot be detected and estimates the head pose based only on the visible head contour and some features (e.g., outline edges, silhouette curvature, or hairline, etc.). The head detector 32 may use techniques such as contour matching or partial feature point tracking.

The vehicle coordinate calibrator 33 establishes a mapping relationship between a camera coordinate system and an actual vehicle coordinate system. This considers the mounting position and angle of the camera (e.g., dashboard, A-pillar, or roof mount, etc.). An initialization process may be required to determine point reference points.

The feature point matching portion 34 matches feature points between consecutive image frames. This is for tracking the movement of the face and head, and it provides the movement information necessary for dynamic calibration (e.g., drift compensation or parameter update, etc.).

The dynamic calibrator 35 adjusts and optimizes system parameters in real-time to adapt to environmental changes (e.g., lighting conditions, vibrations, or cabin temperature changes, etc.) and user movements. The dynamic calibrator 35 may use an algorithm such as Kalman filtering to smooth parameter changes.

A gaze point calculator 36 synthesizes the gaze vector, head pose, and depth information to calculate the user's actual gaze point. The gaze point calculator 36 maps the gaze point to an actual position within the vehicle coordinate system. To reduce the influence of temporary fluctuations, the gaze calculator 36 may include a temporal smoothing algorithm (e.g., moving average or exponential smoothing, etc.).

The post-processor 37 comprehensively analyzes and optimizes the output of all vision algorithms. The post-processor 37 applies various filtering and smoothing techniques (e.g., noise suppression or outlier removal, etc.) to improve the stability of the output and generates final control decision information, which provides a basis for vehicle window operation.

The vehicle window control module 4 is responsible for actually controlling the opening and closing of vehicle windows. The vehicle window control module 4 includes a control feedback portion 41, a left vehicle window 421, a right vehicle window 422, and other vehicle windows.

The control feedback portion 41 feeds back the current status and operation results of the vehicle windows to the system. The control feedback portion 41 may include a position sensor to accurately report the degree to which a vehicle window is open (e.g., 20%, 50%, or fully, etc.). The control feedback portion 41 provides an operation completion confirmation signal to update the system status.

The control feedback portion 41 may control a plurality of vehicle windows simultaneously or sequentially, for example, with a “one-click open” function (e.g., open all windows halfway, open two rear windows only, or close all windows simultaneously, etc.). The control feedback portion 41 may automatically adjust the degree to which a vehicle window is open based on factors such as vehicle speed and outside temperature (e.g., close windows above 80 km/h, slightly open windows in hot weather, etc.). Additionally, the control feedback portion 41 stores a user's preferred vehicle window opening settings (e.g., 30% open for the driver's side, 50% open for the passenger's side, etc.). Furthermore, the control feedback portion 41 has an emergency operation function and may quickly open all vehicle windows in a special situation (e.g., an accident, a fire, or water submersion, etc.). In addition, the control feedback portion 41 is provided with a remote control interface and is integrated with the vehicle's remote control system to allow remote operation of the vehicle windows through a mobile phone application (e.g., an Android or iOS app) or the like.

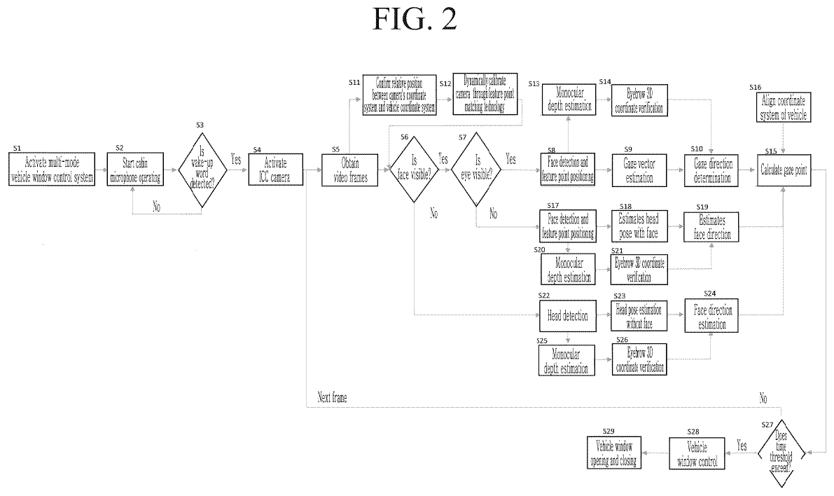

Hereinafter, with reference to FIG. 2, a flow of a vehicle window control method according to an example of the present disclosure will be described.

As shown in FIG. 2, in step S1, a multi-mode vehicle window control system is activated. The activation may be triggered by various methods, such as a physical button in the vehicle (e.g., a door switch, a steering-wheel button, or a center console touch button, etc.), a voice command (e.g., “activate window control,” “start smart window,” or “hello car,” etc.), or the vehicle window control system may be triggered after automatically sensing a driver's request (e.g., by detecting hand gestures or a proximity sensor, etc.). In this example, it may be automatically activated by a voice.

Once the system is activated, a cabin microphone starts operating immediately (S2). The primary task of the microphone is to continuously monitor the driver's voice input within the cabin, especially any wake-up words or control commands that the driver may issue (e.g., “open driver window,” “close passenger window,” or “open all windows halfway,” etc.). The microphone transmits the captured voice signal to the voice recognition module 2 for further analysis.

After the microphone captures the driver's voice signal, the system enters a wake-up word detection step S3. The wake-up word is a preset keyword or phrase designed to activate the control functions of the system (e.g., “Hey Window,” “Car Window,” or a user-defined phrase, etc.). For example, a driver may say a command such as “open the vehicle window” or “close the vehicle window,” and the vehicle window control system determines whether the voice signal detected through voice recognition technology includes these wake-up words.

The accuracy of wake-up word detection significantly impacts the system's response speed and user experience. The wake-up word detector 21 of the voice recognition module 2 must be able to quickly and accurately extract the wake-up word in a complex voice environment (e.g., with engine noise, road noise, or music playback, etc.) and provide a corresponding response. When a wake-up word is detected, the vehicle window control system proceeds to the subsequent step S4. If no wake-up word is detected, the vehicle window control system may continue to maintain a monitoring state until a valid wake-up word is received.

After the vehicle window control system successfully detects the wake-up word, it proceeds to activate an ICC (in-cabin camera) (S4). The camera's main task is to capture a real-time image of the driver's face and transmit this image data to a vision algorithm module for processing. The operation of the camera means that the vehicle window control system transitions from voice input analysis to vision information processing.

The performance of the camera is critical to the effectiveness of the entire vehicle window control system. To ensure the capture of a clear image of the driver's face, especially when changes occur in the driver's facial expression or eye movements (e.g., blinking, squinting, or turning the head, etc.), the camera should have a sufficiently high resolution and frame rate. In addition, the camera must be able to operate under different lighting conditions, for example, it should still be able to capture high-quality images at night or under intense sunlight, or in tunnels, etc.

Once camera calibration is complete, the vehicle window control system begins to obtain video frames from the camera (S5). The obtaining of video frames is a continuous process, and the vehicle window control system continuously obtains the latest image data from the camera and transmits this data to the vision algorithm module for real-time processing.

Since the quality of the video frames directly affects the effectiveness of subsequent steps, after obtaining the video frames, the vehicle window control system typically needs to perform some preliminary processing operations, such as noise reduction and contrast enhancement, or brightness adjustment (e.g., using histogram equalization, temporal denoising, or sharpening filters, etc.). These preliminary processing steps may improve image quality and ensure that the vision algorithm module may analyze high-quality image data, thereby enhancing the overall performance of the vehicle window control system.

After obtaining video frames, a first step analysis task of the vehicle window control system is to determine whether the driver's face is visible (S6). Face visibility detection is implemented through a face detection algorithm among computer vision technologies (e.g., CNN-based detectors, or multi-task cascaded networks, etc.). The vehicle window control system scans all areas of the image to find possible face regions and determines whether the region is clear enough for subsequent processing.

If the driver's face is not detected, it may be because the driver turned their head too far or their face is out of the camera's field of view (e.g., leaning forward, wearing a mask, or blocked by an object, etc.) for some other reason. In this situation, the vehicle window control system skips eye detection and instead attempts to obtain the driver's intention through other methods. If the face is visible and clear, the vehicle window control system may proceed to the next step, namely, eye detection.

Between step S5 and step S6, a dynamic camera calibration steps (S11 and S12) may also be added (e.g., recalibrating the camera after seat adjustment or vibration, etc.). In step S11, the relative position between the camera's coordinate system and the vehicle coordinate system is confirmed to be accurate without error. In step S12, the vehicle window control system may determine the camera's actual position by comparing the image captured by the camera with known feature points within the vehicle using a feature point matching technology.

If a face is detected in step S6 (“Yes” in step S6), the vehicle window control system additionally determines whether the eyes are visible (S7). If no face is detected (“No” in step S6), the vehicle window control system may switch to a head detection flow (transition to step S22 described below).

In step S7, the vehicle window control system determines whether the driver's eyes are likewise clearly visible. Eye visibility detection is realized by analyzing a specific area in the face image (that is, the eye area). The vehicle window control system may determine whether the eyes appear clearly in the image by identifying their shape and position (e.g., pupil center, eyelid contour, or corneal reflection, etc.).

The visibility of the eyes is crucial for subsequent gaze vector estimation. If the eyes are clearly visible, the vehicle window control system may perform eye movement tracking and gaze vector estimation. If the eyes are not visible due to the driver wearing glasses, light reflection, or other reasons (e.g., glare, sunglasses, or shadows, etc.), the vehicle window control system cannot accurately calculate the gaze vector. Therefore, if the eyes are not visible, the vehicle window control system switches to using head pose estimation to infer the driver's gaze direction.

If the eyes are detected in step S7 (“Yes” in step S7), the process proceeds to step S8 described below. If no eyes are detected (“No” in step S7), the process proceeds to step S17 described below.

If the vehicle window control system detects that eyes are visible, it performs eye movement detection and gaze vector estimation. In step S8, face detection and feature point positioning are performed. The vehicle window control system positions and tracks facial features such as the corner of the eye, the tip of the nose, and the corner of the mouth (e.g., left eye corner, right eye corner, or philtrum midpoint, etc.). These feature points provide basic data for subsequent analysis. Subsequently, in step S9, gaze vector estimation is performed, and based on the eye position and pupil direction, the vehicle window control system calculates a user's gaze direction vector. This step is critically important for determining the driver's point of gaze. Subsequently, in step S10, the gaze direction is determined. By combining the gaze vector and head pose information, the vehicle window control system may more accurately determine the driver's actual gaze direction.

After obtaining the gaze vector or head direction information, the vehicle window control system calculates the driver's point of gaze (S15) by combining the coordinate system of the vehicle (S16). The calculation of the point of gaze involves aligning the gaze vector or head direction with the camera position and the coordinate system inside the vehicle to determine the specific location the driver is looking at (e.g., driver's side window, passenger's side window, or sunroof, etc.).

After the face detection and feature point positioning step S8, a transition to step S10 may also occur through monocular depth estimation in step S13 and eyebrow 3D coordinate verification in step S14. In step S13, using a single camera image, the vehicle window control system estimates the distance from the driver's face to the camera. This provides important spatial information for accurate calculation of the point of gaze. In step S14, the vehicle window control system determines the 3D spatial position of the eyebrows, which helps in more accurately estimating the head pose and gaze direction (e.g., eyebrow ridge depth, brow angle, or eyebrow midline coordinates, etc.).

If the vehicle window control system cannot obtain eye information (NO in step S7) (e.g., due to sunglasses, glare, occlusion, or backlighting, etc.), the system instead estimates the driver's head pose by detecting facial feature points. In step S17, face detection and feature point positioning are performed. This step is similar to the situation where eyes are visible (step S8) but focuses more on facial features other than the eyes (e.g., nose tip, mouth corners, eyebrow ridge points, or jawline landmarks, etc.). Subsequently, in step S18, based on the visible facial features, the vehicle window control system estimates the three-dimensional pose of the head (e.g., pitch, yaw, or roll, etc.). Subsequently, in step S19, by combining the head pose information with a body coordinate system of the vehicle, the vehicle window control system estimates an alternative gaze direction (transition to step S15).

If data for monocular depth estimation (step S20) and eyebrow 3D coordinate verification (step S21) exist in step S17, they may be used to provide supplementary information for the final point of gaze estimation (e.g., refining distance scaling, rejecting outliers, or increasing robustness under low light, etc.).

If the driver's head turning angle is too large or partially blocked, so that the face is not visible (NO in step S6), proceed to step S22. In step S22, head detection is performed, and the vehicle window control system recognizes and positions the contour and position of the human head. Subsequently, in step S23, head pose estimation without a face is performed, and the head pose is estimated based only on the head contour and features of the visible part (e.g., silhouette curvature, hairline, or helmet outline, etc.). Subsequently, in step S24, the facial direction is determined. Even when the entire face is not visible, the system may attempt to infer an alternative facial direction. This is used to estimate the driver's point of gaze (transition to step S15).

After confirming the driver's point of gaze, the vehicle window control system must also determine whether the point of gaze satisfies a time threshold requirement (S27). The time threshold refers to the time for which the driver's point of gaze remains stable at a specific position (e.g., longer than one second, two seconds, or three seconds, etc.). Only when the gaze time at a specific position of the driver exceeds a predetermined time threshold, the vehicle window control system may determine that it is a valid control intention.

The purpose of determining the time threshold is to prevent malfunctions such as the driver's unconscious gaze or brief glance (e.g., looking at the mirror or glancing at a screen, etc.). This determination process improves the reliability and user experience of the vehicle window control system by ensuring that the vehicle window control system can perform control operations only when there is a clear intention from the driver.

In step S27, if the threshold is not reached (NO in step S27), the vehicle window control system continues to process the next image frame (returning to step S5) and repeats the entire analysis process. If the time threshold condition is satisfied (YES in step S27), a control signal is generated to be sent to the vehicle window control module 4 (step S28). The control signal includes a combination of the driver's point of gaze information and a voice command, and the vehicle window control module 4 instructs the corresponding window opening or window closing operation (e.g., fully open driver window, close passenger window, or open all windows halfway, etc.). After receiving the control signal, the vehicle window control module 4 executes a corresponding operation according to the command of the control signal (step S29) (e.g., fully opening a driver's side window, closing all passenger windows, or opening a sunroof, etc.). This process signifies the end of the entire flow, whereby the driver's intention has been realized, and the vehicle window control system returns to its initial state, ready to receive the next control request (e.g., a new voice command, a mobile-app remote command, or an emergency override, etc.).

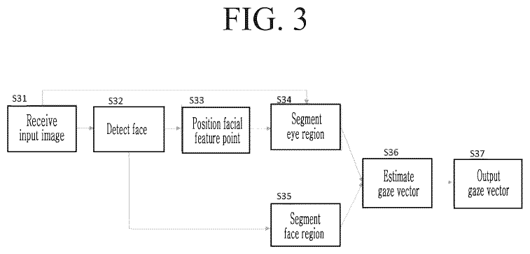

Hereinafter, respective important flows of the example of the present disclosure will be described in detail with reference to FIG. 3 to FIG. 7.

FIG. 3 shows an example of an eye-gaze vector estimation flow according to an example of the present disclosure. The gaze vector estimation algorithm is a key component of the overall multi-mode integrated vehicle control scheme, which may accurately estimate the driver's gaze direction and provide an important basis for subsequent vehicle window control (e.g., for controlling side windows, a sunroof, or a rear window, etc.). First, an input image is received in an image input step S31. The input image is typically a high-quality image frame captured in real time by an in-cabin camera (ICC) (e.g., mounted on the dashboard, on the A-pillar, or on the headliner, etc.). The input image must cover the driver's entire face area to ensure accuracy in subsequent steps. Once the input image is received, the vehicle window control system immediately performs face detection (step S32). This step uses advanced computer vision algorithms (e.g., deep-learned CNNs, MTCNN, or YOLO-based detectors, etc.) to position and recognize a face in the image. Face detection not only determines the presence of a face but also provides its approximate position and extent in the image. If face detection is successful, the next step is to position facial feature points (also referred to as face points) (step S33). This process typically involves recognizing and positioning a plurality of points on the face, including contour points for the eyes, nose, and mouth (e.g., inner/outer eye corners, tip of the nose, or mouth corners, etc.). For gaze estimation, it is most important to accurately position points around the eyes, such as the eyes and eyebrows (e.g., eyebrow ridges, eyelid contours, or pupil centers, etc.). These feature points provide an accurate spatial reference for subsequent eye region segmentation and gaze estimation. Using the facial feature point information obtained in step S33, the gaze vector estimation algorithm can accurately determine and segment the eye region in step S34. The eye region segmentation step S34 narrows the focus of analysis to the most relevant region for gaze estimation, thereby improving the efficiency and accuracy of subsequent processing. When segmenting, it is usually necessary to include the entire eye region (including the eyelids, eyebrows, and some surrounding areas, e.g., upper cheek or temple zones, etc.), ensuring that all eye movements and related vision information are captured. However, the eye region may also be directly segmented according to the image input in the image input step S31 (step S34).

Simultaneously, the gaze vector estimation algorithm may segment the entire face region based on the face detection results of the face detection step S32. The eye region is the main basis for gaze estimation, but the pose and orientation of the entire face also have a significant impact on gaze estimation. For example, tilting or turning the head (e.g., nodding, yawning, or looking sideways, etc.) may directly affect the position of the eyeball relative to the face, thereby influencing the determination of gaze direction.

Based on the results of the eye region segmenting step S34 and the face region segmenting step S35, gaze vector estimation is performed (step S36). The gaze vector estimation step S36 comprehensively uses the segmented eye region image and face region image and estimates a gaze vector through complex computer vision and machine learning algorithms (e.g., PCCR, 3D gaze regression, or hybrid head-eye models, etc.). Finally, the estimated gaze vector is output (step S37). This vector typically represents a single unit vector in 3D space, indicating the direction of the driver's gaze. The vector may be additionally combined with a vehicle coordinate system to determine a position in the vehicle that the driver actually gazes at (e.g., driver's side window, rear passenger window, or climate-control panel, etc.).

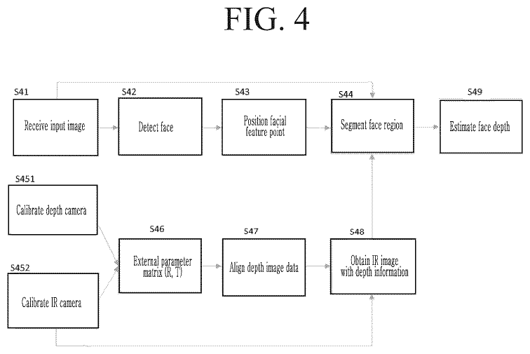

FIG. 4 shows an example of a face depth estimation flow according to an example of the present disclosure. A face depth estimation algorithm is an important component of the multi-mode integrated vehicle control scheme and is intended to accurately estimate 3D spatial information of a driver's face, providing core data support for subsequent gaze tracking and interactive control (e.g., for depth-aided gaze tracking or driver identification, etc.). First, an image captured by an infrared (IR) camera is received in image input step S41. The reason for choosing IR images instead of visible light images is that IR images provide stable face images even in various lighting conditions (including nighttime, low-light environments, or strong backlight, etc.), which improves the adaptability and reliability of the system. After receiving the IR image, the system immediately performs face detection (step S42). This step uses a face detection algorithm specifically optimized for IR images based on deep learning methods such as CNN (e.g., IR-adapted ResNet or MobileNet, etc.). The purpose of this step is to position the position and approximate contour of the face in the image. After successfully detecting a face, the algorithm performs accurate positioning of facial feature points (or facial points) (step S43). This process recognizes and positions a plurality of facial points, such as the corners of the eyes, the tip of the nose, and the corners of the mouth (e.g., left and right nostrils, eyebrow arches, or chin tip, etc.). These feature points not only provide a reference for subsequent face ROI segmenting but also provide important facial structure information for depth estimation. Based on the face position and feature point information obtained above, the face depth estimation algorithm accurately segments the face region (step S44). This step concentrates the focus of analysis on the most relevant face region, thereby improving the efficiency and accuracy of subsequent depth estimation.

At the same time, face depth information labels must be obtained. Through depth camera calibration (step S451) and IR camera calibration (step S452), an external parameter matrix (R, a rotation matrix, and T, a translation vector) between the two cameras is calculated (step S46). These parameters represent the relative position and orientation of the two cameras in 3D space, providing a basis for subsequent image alignment (e.g., pixel-to-pixel mapping, disparity correction, or depth scaling, etc.). Using the calculated external parameter matrix, the system accurately aligns the depth image captured by the depth camera with the IR image captured by the IR camera (step S47). This process ensures that each IR image pixel corresponds to an accurate depth value. Through the alignment process, an IR image with depth information is obtained (step S48).

By combining the IR image with depth information obtained in step S48, the segmented face ROI image is input into a specially trained depth estimation model. This model may be a deep learning-based architecture, such as a variation of U-Net or ResNet (e.g., U-Net++ or ResNet-50 with skip connections, etc.), and has been trained on a large dataset of face data with depth labels. The model outputs a precise face depth map (step S49) by comprehensively using the texture information of the IR image and the depth information extracted in the previous step (e.g., producing a 3D point cloud of the face, normalized depth layers, or mesh representations, etc.).

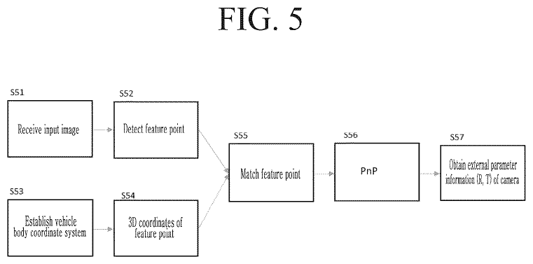

FIG. 5 shows an example of a camera dynamic calibration flow according to an example of the present disclosure (e.g., recalibration after a seat moves, camera is replaced, or vibration occurs, etc.). A camera dynamic calibration flow is provided for accurately determining the position and pose of a vehicle-mounted camera relative to a vehicle body in real-time, and it provides an accurate spatial reference for subsequent vision analysis and interactive control. First, in image input step S51, a real-time image captured by the vehicle-mounted camera is received (e.g., a dashboard camera, an A-pillar camera, or a roof-mounted camera, etc.). After receiving the image, the system immediately performs feature point detection (step S52). At the same time, the system establishes a vehicle body coordinate system (step S53) and finds the 3D coordinates of the feature points on the vehicle body coordinate system (step S54) (e.g., dashboard corners, mirror mounts, or seat headrest landmarks, etc.). Subsequently, the feature points in the image are matched with the feature points in the vehicle body coordinate system (step S55), and the 2D coordinates of the matched feature points in the image and the 3D coordinates in the vehicle body coordinate system are input into a PnP algorithm (step S56) to obtain the extrinsic parameter information (R, T) of the camera with respect to the vehicle body coordinate system (step S7).

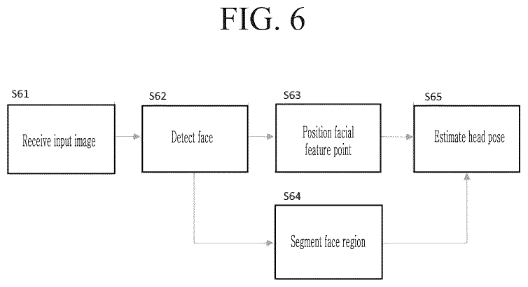

FIG. 6 shows an example of a head pose estimation flow with a face according to an example of the present disclosure. First, in image input step S61, real-time video data from a vehicle-mounted camera is received. Subsequently, face detection is performed for each input image frame (step S62). After detecting a face, the system performs accurate positioning of facial feature points (or facial points) (step S63) (e.g., eye corners, nose tip, mouth corners, or eyebrow midpoints, etc.). At the same time, the system segments a region containing a complete face (step S64). Thereafter, the system inputs the segmented facial image and the facial feature point coordinate information into a dedicated face pose estimation model, and at this time reverts to the driver's head pose (step S65).

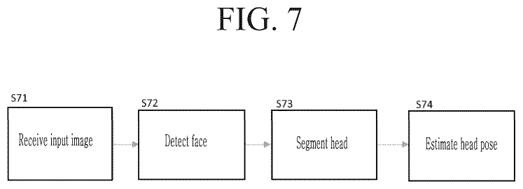

FIG. 7 shows an example of a head pose estimation flow without a face (e.g., when the driver wears sunglasses, a mask, or turns away, etc.) according to an example of the present disclosure. In image input step S71, if other algorithms determine that the driver's face has not been detected, head detection is performed on the input video data (step S72), and after obtaining the coordinate information of the driver's head, an ROI segmenting is performed on the driver's head to obtain a segmented head image (step S73) (e.g., capturing silhouette edges, hairline, or helmet outline, etc.), inputted into the faceless head pose algorithm, and at this time, the driver's head pose is estimated (step S74).

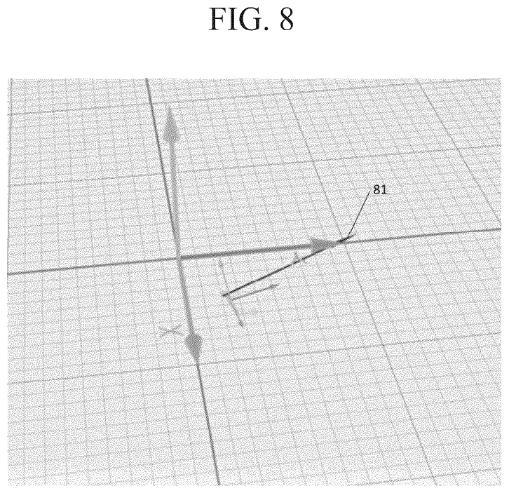

FIG. 8 shows an example of an estimation result of an attention direction vector (e.g., pointing toward a side window, dashboard control, or infotainment screen, etc.) according to an example of the present disclosure. Two coordinate axis systems are shown in the drawing. The large coordinate axis is the calibrated vehicle body coordinate system, and the small coordinate axis is the calculated face/head pose. An arrow 81 indicates the calculated direction of attention. By aligning the driver's face pose or head pose with the vehicle body coordinate system, the system may accurately determine the driver's direction of attention within the vehicle body coordinate system.

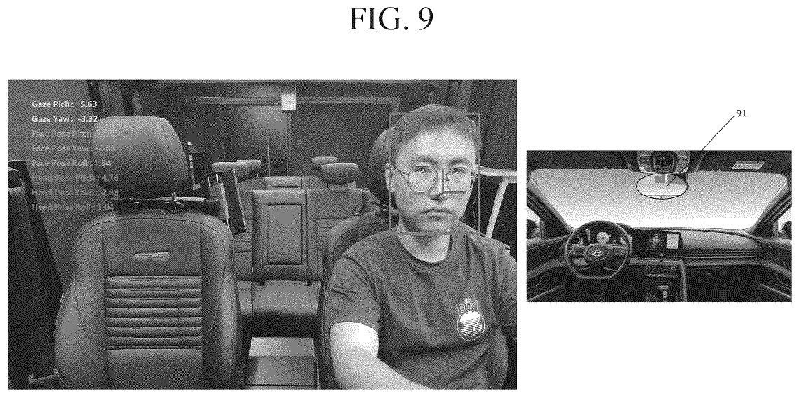

The system screenshot of FIG. 9 shows how the system uses a gaze estimation algorithm to determine the attention region when the driver's eyes are visible (e.g., during daylight with no occlusion, etc.). A right elliptical region 91 in the drawing schematically represents the driver's attention focus region calculated by the system. If the driver's eyes are within the visual range, the system may determine the driver's gaze direction through a high-precision gaze tracking algorithm and estimate the specific region of attention.

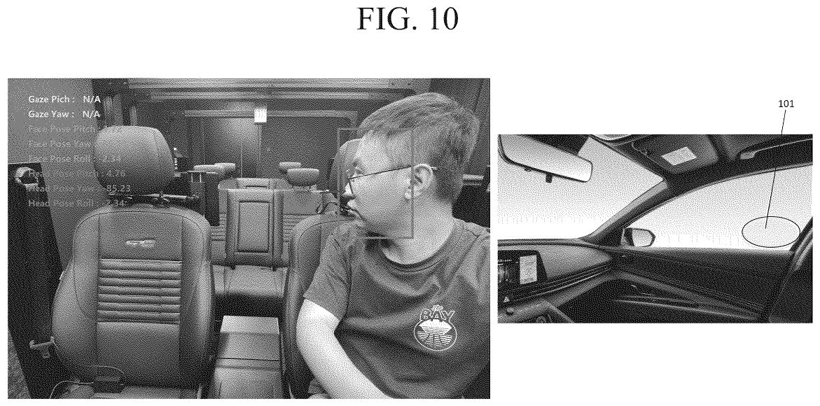

The system screenshot of FIG. 10 shows how the system uses a face pose algorithm to determine the region of attention when the driver's eyes are not visible but the face is visible (e.g., wearing sunglasses, dim lighting, or brief occlusion, etc.). In this case, the system analyzes the driver's face pose to estimate the direction of attention. A right elliptical region 101 in the drawing similarly schematically represents the attention focus region calculated by the system. In application scenarios of the face pose algorithm, the system may still make valid guesses about the driver's attention direction when the eyes are not visible. This technical effect is particularly applicable when the driver is wearing sunglasses or in a dark environment where eye information cannot be accurately captured by the camera. Through analysis of facial feature points (for example, the tip of the nose, corners of the eyes, corners of the mouth, or eyebrow ridge points, etc.), the system may infer the driver's face direction and accordingly estimate the possible direction of attention. This technical effect complements the shortcomings of relying solely on eye tracking and improves the system's adaptability to complex driving environments. Even when the driver's face is partially obscured, the system may still maintain tracking of their direction of attention, thereby ensuring that the intelligent control functions of the vehicle-mounted device are not affected.

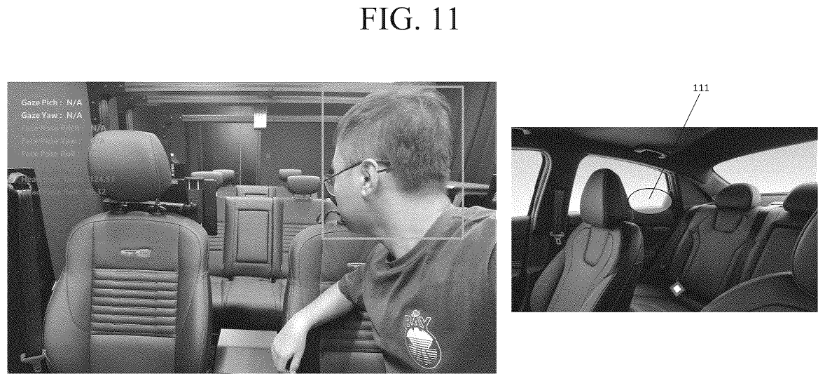

The system screenshot in FIG. 11 shows how the system uses the face pose algorithm to determine the region of attention when neither the driver's eyes nor face are visible (e.g., complete occlusion, looking backwards, or wearing a full-face helmet, etc.). In this situation, the system analyzes the driver's head pose and estimates the direction of attention. A right elliptical region 111 in the drawing similarly schematically represents the attention focus region calculated by the system (e.g., toward a rear passenger seat, an infotainment screen, or a side window, etc.). Application scenarios of the head pose algorithm typically occur when the driver's face and eyes are simultaneously occluded or completely out of the camera's view (e.g., wearing a full-face helmet, turning completely backward, or leaning out of frame, etc.). By analyzing the head pose, the system may estimate the driver's head direction and thereby determine the possible region of attention without requiring eye-tracking data. The estimation of the head pose involves analyzing the overall head contour and relative position (e.g., hairline shape, ear position, or shoulder alignment, etc.), and this algorithm ensures that even when the system's face information is completely lost, it may still reasonably estimate the driver's direction of attention (e.g., for safety alerts, window control, or driver-assist functions, etc.). This further improves the robustness and adaptability of the system. In extreme situations, even when the driver looks back at the rear seat or turns their head sharply (e.g., checking blind spots or speaking to a rear passenger, etc.), the system may still maintain monitoring of the driver's attention, thereby preventing malfunctions caused by incorrect determination regarding the direction of attention.

In summary, the example of the present disclosure provides a single multi-modal integrated driver attention tracking system that integrates a gaze estimation algorithm, a face pose algorithm, and a head pose algorithm. Whether the driver's eyes are visible, the driver's face is visible, or neither is visible, the system may effectively determine the driver's attention direction by relying on different algorithms. Through the collaborative operation of these algorithms, the system may still accurately capture the driver's intent even in complex and diverse driving environments, thereby enabling intelligent vehicle control operations.

This multi-mode integrated technical design not only improves the stability and reliability of the system but also significantly enhances the user experience. The driver may complete control of the vehicle-mounted device using only natural gaze or head movements, without complex manipulations. This user-friendly design reduces the driver's operational burden and helps to mitigate safety risks that may arise during the driving process.

Through the example of the present disclosure, the vehicle control system may appropriately adapt to the operating habits of different drivers and environmental changes, providing a better intelligent and convenient driving experience. These technical effects may have a profound impact on future intelligent driving systems and lay a solid foundation for realizing a higher level of autonomous driving.

While this disclosure has been described in connection with what is presently considered to be practical examples, it is to be understood that the disclosure is not limited to the disclosed examples, but, on the contrary, is intended to cover various modifications and equivalent arrangements that are included within the spirit and scope of the appended claims.

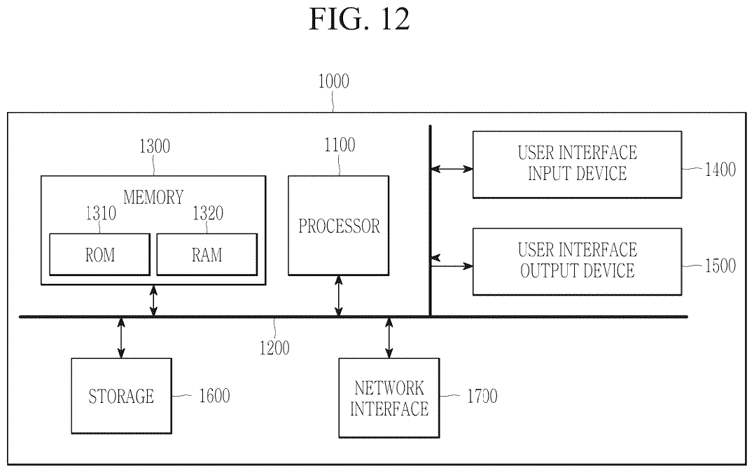

FIG. 12 shows an example computing system (e.g., a vehicle window control device or any other apparatus). One or more modules, controllers, processors, etc. described herein, such as one or more components of the vehicle window control device, any other components, devices, or systems disclosed herein, may be implemented by or in the computing system as shown in FIG. 12.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An example of the present disclosure provides a vehicle window control method that controls a plurality of vehicle windows of a vehicle. The method may include a voice wake-up step of detecting a user's spoken voice wake-up word using a vehicle-mounted microphone and turning on a vehicle-mounted camera based on a specific wake-up word being detected; a face and head detection step of performing face detection and head detection on the user using the vehicle-mounted camera to obtain image data of the user's face and head; an attention region estimation step of analyzing a face state of the user using the image data of the face and head obtained in the face and head detection step, estimating a user's gaze based on detection of the user's face and detection of the user's eyes on the user's face, setting a projection region of the vehicle toward which the user's gaze is directed as an attention region, estimating a user's face pose based on the detection of the user's face but the absence of the user's eyes from the user's face, setting the projection region of the vehicle toward which the user's face is directed as the attention region, detecting the user's head and estimating a user's head pose based on the absence of the user's face, and setting the projection region of the vehicle toward which the user's head is directed as the attention region; an attention region processing step of aligning the attention region obtained by calculation in the attention region estimation step with a vehicle body coordinate system to determine specific coordinates of the user's attention on the vehicle window; and a vehicle window control step of performing opening or closing control of the vehicle window based on the wake-up word according to the coordinates of the vehicle window obtained in the attention region processing step.

The attention region estimation step may include a facial point detection and glabella depth estimation step, and in the facial point detection and glabella depth estimation step, point detection may be performed on the detected face of the user to obtain coordinate information of facial feature points, and glabella depth may be estimated using the coordinate information of the facial feature points to determine depth information of the user's face in a three-dimensional space.

In the vehicle window control step, whether a vehicle window control manipulation is to be performed may be determined based on a duration threshold, and the vehicle window control manipulation may be performed based on a time for which the user has gazed at a specific position exceeding a predetermined duration threshold.

The method may further include a camera dynamic calibration step between the voice wake-up step and the face and head detection step, wherein in the camera dynamic calibration step, dynamic calibration may be performed on the vehicle-mounted camera to obtain external parameter information of the vehicle-mounted camera with respect to the vehicle body coordinate system to ensure accuracy of the camera at different positions.

Another example of the present disclosure provides a vehicle window control device that controls a plurality of vehicle windows of a vehicle. The control device may include a voice recognition module configured to detect a user's spoken voice wake-up word using a vehicle-mounted microphone and turn on a vehicle-mounted camera based on a specific wake-up word being detected; a face and head detection module configured to perform face detection and head detection on the user using the vehicle-mounted camera to obtain image data of the user's face and head; an attention region estimation module configured to analyze a face state of the user using the image data of the face and head obtained by the face and head detection module, estimate a user's gaze based on detection of the user's face and detection of the user's eyes on the user's face, set a projection region of the vehicle toward which the user's gaze is directed as an attention region, estimate a user's face pose based on the detection of the user's face but the absence of the user's eyes from the user's face, set the projection region of the vehicle toward which the user's face is directed as the attention region, detect the user's head and estimate a user's head pose based on the absence of the user's face, and set the projection region of the vehicle toward which the user's head is directed as the attention region; an attention region processing module configured to align the attention region obtained by calculation by the attention region estimation module with a vehicle body coordinate system to determine specific coordinates of the user's attention on the vehicle window; and a vehicle window control module configured to perform opening or closing control of the vehicle window based on the wake-up word according to the coordinates of the vehicle window obtained in the attention region processing module.

The attention region estimation module may further include a facial point detection and glabella depth estimation module, and the facial point detection and glabella depth estimation module may be configured so that point detection is performed on the detected face of the user to obtain coordinate information of facial feature points, and glabella depth is estimated using the coordinate information of the facial feature points to determine depth information of the user's face in a three-dimensional space.

The vehicle window control module may be configured so that whether a vehicle window control manipulation is to be performed is determined based on a duration threshold, and the vehicle window control manipulation is performed based on a time for which the user has gazed at a specific position exceeding a predetermined duration threshold.

The control device may further include a camera dynamic calibration module, wherein the camera dynamic calibration module may be configured so that dynamic calibration is performed on the vehicle-mounted camera to obtain external parameter information of the vehicle-mounted camera with respect to the vehicle body coordinate system to ensure accuracy of the camera at different positions.

An example of the present disclosure may provide a single multi-modal integrated driver attention tracking system by integrating a gaze estimation algorithm, a face pose algorithm, and a head pose algorithm. Whether the driver's eyes are visible, the driver's face is visible, or neither is visible, the system may effectively determine the driver's attention direction by relying on different algorithms. Through the collaborative operation of these algorithms, the system may still accurately grasp the driver's intent even in complex and diverse driving environments, thereby realizing intelligent vehicle control operations.

What is claimed is:

1. A method performed by an apparatus of a vehicle, the method comprising:
detecting, via a microphone of the vehicle, a spoken preset wake-up word associated with a user of the vehicle;
turning on a sensor of the vehicle based on the detecting of the spoken preset wake-up word;
obtaining, via the sensor, image data associated with face and head of the user;
determining, based on the image data, a face state of the user,
performing at least one of:
when the face state indicates that eyes on the face are visible, estimating a gaze of the user and setting, as a first attention region, a projection region of the vehicle toward which the gaze is directed;
when the face state indicates that eyes on the face are invisible and the face is visible, estimating a face pose of the user and setting, as a second attention region, a projection region of the vehicle toward which the face pose is directed; or
when the face state indicates that the face is invisible, estimating a head pose of the user and setting, as a third attention region, a projection region of the vehicle toward which the head pose is directed;
aligning one attention region of the first attention region, the second attention region, or the third attention region, with a body coordinate system of the vehicle to determine coordinates of attention of the user on a window of the vehicle; and
based on the spoken preset wake-up word and the coordinates of the attention on the window, performing opening or closing control of the window.

2. The method of claim 1, wherein the determining of the face state of the user comprises:
performing point detection on the face to obtain coordinate information of facial feature points; and
estimating glabella depth using the coordinate information of the facial feature points to determine depth information associated with the face in a three-dimensional space.

3. The method of claim 1, wherein the performing of the opening or closing control of the window is based on the attention remaining longer than a predetermined duration threshold.

4. The method of claim 2, wherein the performing of the opening or closing control of the window is based on a determination that the attention remains on a preset position in the vehicle longer than a predetermined duration threshold.

5. The method of claim 1, further comprising:
after the detecting of the spoken preset wake-up word and before the obtaining of the image data, performing dynamic calibration on the sensor to obtain external parameter information of the sensor with respect to the body coordinate system, wherein the external parameter information is used to align the image data with the body coordinate system when the sensor is at different positions.

6. The method of claim 2, further comprising:
between the detecting of the spoken preset wake-up word and the obtaining of the image data, obtaining external parameter information of the sensor with respect to the body coordinate system, wherein the external parameter information is used to align the image data with the body coordinate system.

7. An apparatus of a vehicle, the apparatus comprising:
a microphone configured to detect a spoken preset wake-up word of a user;
a sensor configured to obtain image data associated with face and head of the user; and
a processor circuit configured to:
turn on the sensor based on the spoken preset wake-up word,
determine, based on the image data, a face state of the user,
based on the face state of the user indicating that eyes on the face are visible, estimate a gaze of the user and set, as a first attention region, a projection region of the vehicle toward which the gaze is directed,
based on the face state of the user indicating that eyes on the face are invisible and the face is visible, estimate a face pose of the user and set, as a second attention region, a projection region of the vehicle toward which the face pose is directed,
based on the face state of the user indicating that the face is invisible, estimate a head pose of the user and set, as a third attention region, a projection region of the vehicle toward which the head pose is directed,
align one attention region of the first attention region, the second attention region, or the third attention region, with a body coordinate system of the vehicle to determine coordinates of attention of the user on a window of the vehicle, and
based on the spoken preset wake-up word and the coordinates of the attention on the window, perform opening or closing control of the window.

8. The apparatus of claim 7, wherein the processor circuit is configured to:
perform point detection on the face to obtain coordinate information of facial feature points, and
estimate glabella depth using the coordinate information of the facial feature points to determine depth information associated with the face in a three-dimensional space.

9. The apparatus of claim 7, wherein the processor circuit is configured to perform the opening or closing control of the window based on the attention remaining longer than a predetermined duration threshold.

10. The apparatus of claim 8, wherein the processor circuit is configured to perform the opening or closing control of the window based on a determination that the attention remains on a preset position in the vehicle longer than a predetermined duration threshold.

11. The apparatus of claim 7, wherein the processor circuit is configured to perform dynamic calibration on the sensor to obtain external parameter information of the sensor with respect to the body coordinate system, wherein the external parameter information is used to align the image data with the body coordinate system when the sensor is at different positions.

12. The apparatus of claim 8, wherein the processor circuit is configured to obtain external parameter information of the sensor with respect to the body coordinate system, wherein the external parameter information is configured to be used to align the image data with the body coordinate system.

13. A vehicle comprising:
at least one sensor configured to obtain interior data of the vehicle, wherein the interior data comprises at least one of voice data of an occupant and image data of the occupant captured within a cabin of the vehicle; and
a processor circuit configured to:
detect, from the voice data, a voice command associated with a window of the vehicle,
process, from the image data, at least one of a gaze vector, a face pose, or a head pose of the occupant to estimate an attention region of the occupant,
determine, based on the estimated attention region, a position of the window,
output, based on the detected voice command and the position of the window, a signal indicating to operate the window, and
control, based on the signal, operation of the window.

14. The vehicle of claim 13, wherein the processor circuit is configured to detect a user-defined wake-up word as part of the voice command associated with the window.

15. The vehicle of claim 13, wherein the processor circuit is configured to prioritize execution of the operation of the window based on a voice command of a driver of the vehicle over a voice command of a passenger of the vehicle.

16. The vehicle of claim 13, wherein the processor circuit is configured to, when eyes of the occupant are invisible, estimate the attention region based on the face pose.

17. The vehicle of claim 13, wherein the processor circuit is configured to, when both eyes and face of the occupant are invisible, estimate the attention region based on the head pose.

18. The vehicle of claim 13, wherein the processor circuit is configured to generate the signal based on the attention region remaining on the window for at least a predetermined time period.

19. The vehicle of claim 13, wherein the processor circuit is configured to, based on determining lighting conditions inside the cabin as insufficient, obtain an infrared image of the occupant and perform face depth estimation using the infrared image.

20. The vehicle of claim 13, wherein the processor circuit is configured to, based on determining at least one of a vehicle speed, an outside temperature, or a stored user preference, control a degree of opening of the window.
